(19) United States
(12) Patent Application Publication
(10) Pub. No.: US 2018/0231147 A1
(43) Pub. Date: Aug. 16, 2018

(54) ADJUSTABLE SUPPORT

(71) Applicant: Bechtel Oil, Gas and Chemicals Inc., Houston, TX (US)

(72) Inventor: Ismat ELJAOUHARI, Sugar Land, TX (US)

(21) Appl. No.: 15/506,998

(22) PCT Filed: Sep. 29, 2016
(86) PCT No.: PCT/US16/54520

§ 371 Date: Feb. 27, 2017

Related U.S. Application Data
(60) Provisional application No. 62/279,159, filed on Jan. 15, 2016.

(51) Int. Cl. F16L 3/237; F16B 5/06; F16L 3/20; F16L 3/10; F16L 3/11; F16B 7/14; F16L 3/24

(52) U.S. Cl. CPC F16L 3/237; F16B 5/0685; F16L 3/20; F16L 3/227; F16L 3/11; F16B 7/14; F16L 3/24; F16L 3/1091

(57) ABSTRACT

An adjustable support, which includes a stationary member and an adjustable member coupled to the stationary member in a manner that permits movement of the adjustable member relative to the stationary member and securing the adjustable member to the stationary member at a preferred position.

### FIELD OF THE DISCLOSURE

The present disclosure generally relates to an adjustable support. More particularly, the present disclosure relates to an adjustable support, which includes a stationary member and an adjustable member coupled to the stationary member in a manner that permits movement of the adjustable member relative to the stationary member and securing the adjustable member to the stationary member at a preferred position.

### BACKGROUND

Small bore pipe supports, which are used to support pipes with less than 2 inch diameters, are typically procured as bulk material and shipped to a project site for fabrication and installation. There may be 4000-6000 supports on a project site. In FIG. 1, an elevational view illustrates one type of fixed conventional support 100 for small bore pipes. The support 100 includes a base 102, a brace 104 and another base 106 for supporting a pipe 108. The support 100 is one integral component that is fixed to a surface 110 using bolts 111 positioned through respective holes in the base 102 and surface 110. The support 100 also includes a clamp 112 detachably secured to the another base 106 by bolts 114 positioned through respective holes in the another base 106. In FIG. 2, an elevational view illustrates another type of fixed conventional support 200 for small bore pipes. The support 200 includes a base 202, a brace 204 and another base 206 for supporting a pipe 208. The support 200 is one integral component that is fixed to a surface 210. The support 200 also includes a clamp 212 detachably secured to the another base 206 by bolts 214 positioned through respective holes in the another base 206.

One advantage to shipping supports as bulk material is not having to track the supports. If the supports are prefabricated, someone must track the exact support for each design difference prior to installation. When there are thousands of supports that all look alike, but only differ by a few millimeters, tracking becomes a major effort and responsibility. Prefabrication also creates more effort to design the supports to exact dimensions. Conversely, a significant disadvantage to shipping thousands of supports to a project site for fabrication and installation is the fabrication effort to build these supports at the project site (e.g. measure, cut, weld and touch up coating), particularly when it's a modular project with a tight schedule or the project is at a remote location.

There is therefore, a need for a support that is prefabricated, fully adjustable, and interchangeable with other supports so that tracking is not necessary.

### BRIEF DESCRIPTION OF THE DRAWINGS

The present disclosure is described with reference to the accompanying drawings, in which like elements are referenced with like reference numbers, and in which:

FIG. 1 is an elevational view illustrating one type of fixed conventional support.

FIG. 2 is an elevational view illustrating another type of fixed conventional support.

FIGS. 3A-3B are elevational views illustrating one embodiment of an adjustable support comprising a stationary member and a separate adjustable member uncoupled (3A) and coupled (3B).

FIG. 4 is a top view illustrating the adjustable member in FIG. 3A along 3-3.

FIGS. 5A-5B are elevational views illustrating another embodiment of an adjustable support comprising a stationary member and a separate adjustable member uncoupled (5A) and coupled (5B).

FIG. 6 is a bottom view illustrating the adjustable member in FIG. 5A along 5-5.

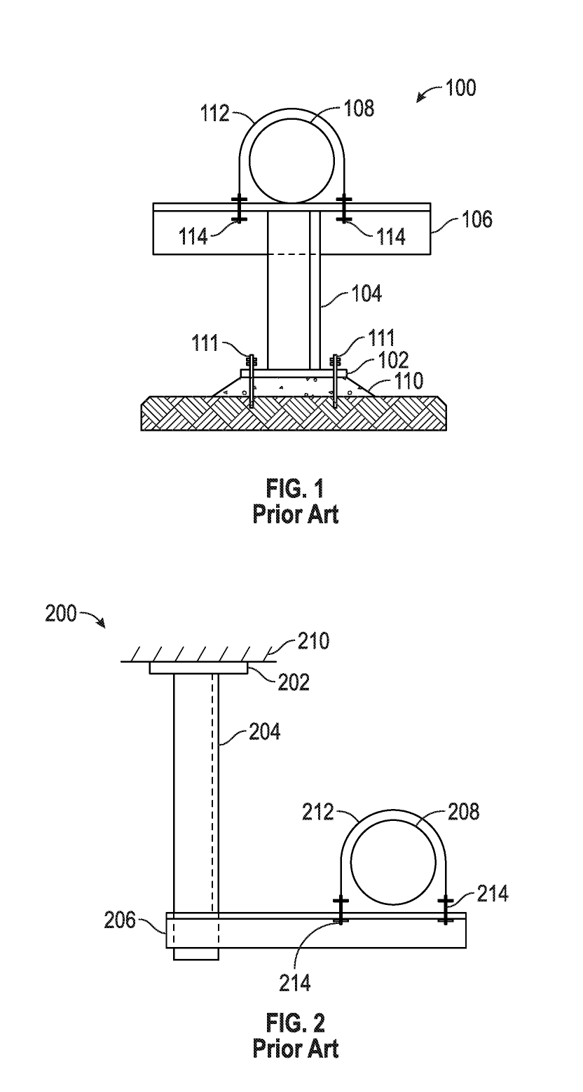

### DETAILED DESCRIPTION OF THE PREFERRED EMBODIMENTS

The present disclosure overcomes one or more of the prior art disadvantages with an adjustable support, which includes a stationary member and an adjustable member coupled to the stationary member in a manner that permits movement of the adjustable member relative to the stationary member and securing the adjustable member to the stationary member at a preferred position.

In one embodiment the present disclosure includes an adjustable support, which comprises: i) a stationary member having a base attached to a brace; and ii) an adjustable member coupled to the stationary member, the adjustable member having another base attached to another brace and the another base including at least one of a base slot and another base slot for receipt of a plurality of different sized clamps.

In another embodiment, the present disclosure includes a method for a method for adjusting a support, which comprises: i) securing a base of a stationary member to a fixed surface; ii) coupling an adjustable member to the stationary member, the adjustable member having another base with at least one of a base slot and another base slot; iii) moving the adjustable member in a direction perpendicular to the base of the stationary member; iv) securing the adjustable member to the stationary member at one of a minimum position, a maximum position and a position between the minimum position and the maximum position; and v) securing a clamp within at least one of the base slot and the another base slot, the clamp having a predetermined size.

The subject matter of the present disclosure is described herein with specificity; however, the description itself is not intended to limit the scope of the disclosure. The subject matter thus, might also be embodied in other ways, to include different structures, steps and/or combinations similar to those described herein in conjunction with other present or future technologies. Moreover, although the term “step” may be used herein to describe different elements of methods employed, the term should not be interpreted as implying any particular order among or between various steps herein disclosed unless otherwise expressly limited by the description to a particular order.

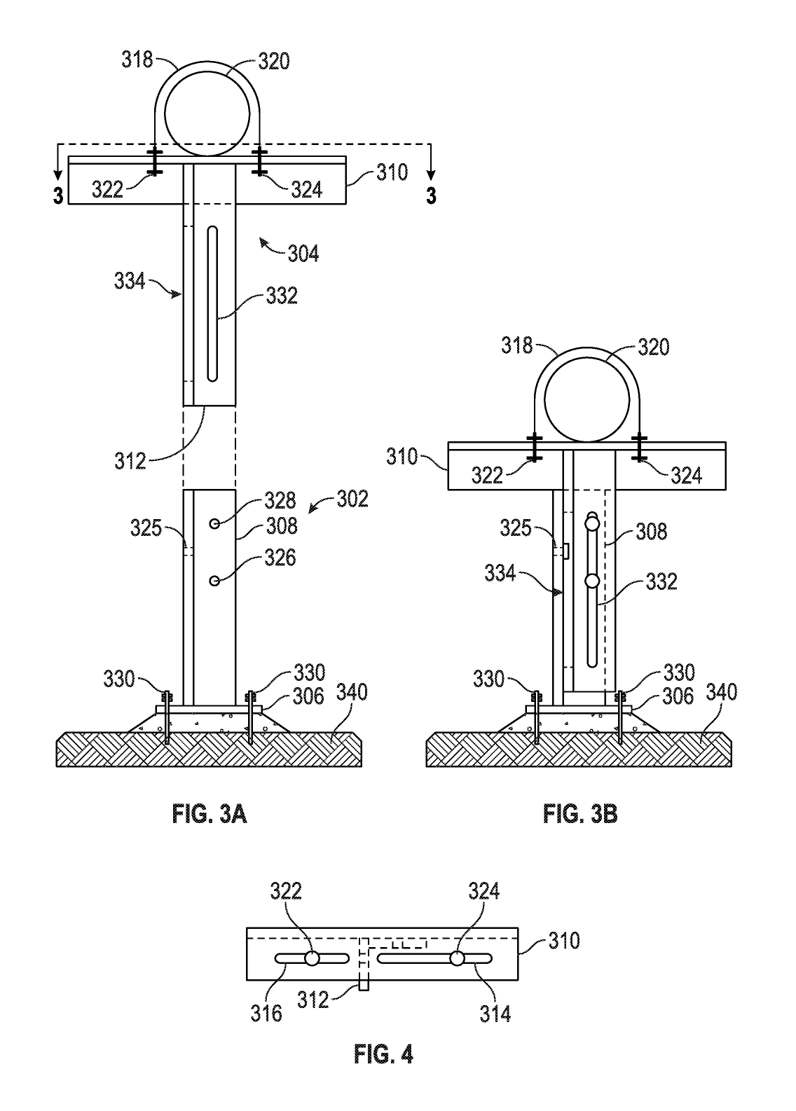

Referring now to FIGS. 3A-3B, elevational views illustrate one embodiment of an adjustable support comprising a stationary member 302 and a separate adjustable member 304 uncoupled (3A) and coupled (3B). The stationary member 302 includes a base 306 attached to a brace 308. The adjustable member 304 is coupled to the stationary member 302 and includes another base 310 attached to another brace 312 between each end of the another base 310, which supports an object (e.g. pipe 320). The another base 310 includes a base slot 314 and another base slot 316, which are illustrated in FIG. 4. In FIG. 4, a top view of the adjustable member 304 in FIG. 3A along 3-3 illustrates the base slot 314 and the another base slot 316 for receipt of a plurality of different sized clamps. The base slot 314 and the another base slot 316 are preferably positioned opposite each other relative to a position where the another brace 312 is attached to the another base 310. The base slot 314 and the another base slot 316 may have the same or different lengths. A clamp 318 has a preferred predetermined size based on a size of the object (e.g. pipe 320) to secure the object to the another base 310 and restrict lateral movement of the object. One end of the clamp 318 is secured within the base slot 316 by bolt 322 and another end of the clamp 318 is secured within the another base slot 314 by bolt 324. The base slot 314 and the another base slot 316 permit receipt of a plurality of different sized clamps to secure different sized objects to the another base 310.

The brace 308 includes one opening 325 on one side of the brace 308 and two openings 326, 328 on another side of the brace 308. The one opening 325 and the two openings 326, 328 are also positioned near one end of the brace 308 opposite another end of the brace 308 attached to the base 306. Alternatively, the one opening 325 may be likewise positioned on one side of the another brace 312 and the two openings 326, 328 may be likewise positioned on another side of the another brace 312. Both embodiments permit maximum adjustment between the stationary member 302 and the adjustable member 304. Other designs may be also be employed to achieve the same function such as using more or fewer openings on the one side of the brace 308 and/or on the another side of the brace 308. In both embodiments, the one opening 325 is positioned in a plane equidistantly between each respective plane within which the two openings 326, 328 are positioned to also permit maximum adjustment between the stationary member 302 and the adjustable member 304. Because the one opening 325 and the two openings 326, 328 each are designed for receipt of a respective bolt, their positioning further permits free access to adjust (tighten/loosen) the bolt positioned through the one opening 325 without interference with each bolt positioned through the respective two openings 326, 328. The base 306 is secured to a fixed surface (e.g. floor 340) by a plurality of bolts 330 or, alternatively, screws.

The another brace 312 includes a brace slot 332 on one side of the another brace 312 and another brace slot 334 on another side of the another brace 312. The brace slot 332 and the another brace slot 334 may have the same or different lengths, which are constrained by the length of the another brace 312. The length of the brace slot 332 and the another brace slot 334, however, is preferably maximized within the length of the another brace 312 without compromising the stability of the adjustable support. Alternatively, the brace slot 332 may be likewise positioned on one side of the brace 308 and the another brace slot 334 may be likewise positioned on another side of the brace 308. In both embodiments, the brace slot 332 and the another brace slot 334 are aligned with a respective one of the one opening 325 and the two openings 326, 328 for receipt of the bolt positioned through the respective one opening 325 and the two openings 326, 328. In this manner, the adjustable member 304 becomes slideably coupled to the stationary member 302 and may be moved in a direction perpendicular to the base 306 of the stationary member 302 from a minimum extended position to a maximum extended position. The adjustable member 304 may thus, be secured to the stationary member 302 at one of the minimum extended position, the maximum extended position and a position between the minimum extended position and the maximum extended position using the bolts positioned through the respective one opening 325 and the two openings 326 328 and the respective brace slot 332 and the another brace slot 334. Preferably, each bolt is an A 325 grade or better and may be secured to the proper tension/torque. One locking nut A194-2H for each bolt restricts slipping and the load indicating washer confirms the preloaded tension/torque have been achieved and a uniform distribution of stress about the contact area without having to take frequent measurements. Other coupling mechanisms and slot arrangements, however, may be employed to similarly move and secure the adjustable member.

Preferably, the brace 308, the another base 310 and the another brace 312 are 90° angle iron, however, may be made from any other material similar in strength, without an angle and/or with additional 90° angle iron for further support in the form of a square tubular design. The brace 308, the another base 310 and the another brace 312 may also have different lengths, which are determined by the support parameters such as the size and weight of the object to be supported. The base 306 may be attached to the brace 308 by a fillet weld. Likewise, the another base 310 may be attached to the another brace 312 by a fillet weld. Other techniques and means, however, may be employed to attached the same components while maintaining the required stability for support. The adjustable support illustrated in FIGS. 3-4 evenly distributes the load from the weight of the object supported so that less stress is imposed at each point where the foregoing components are attached.

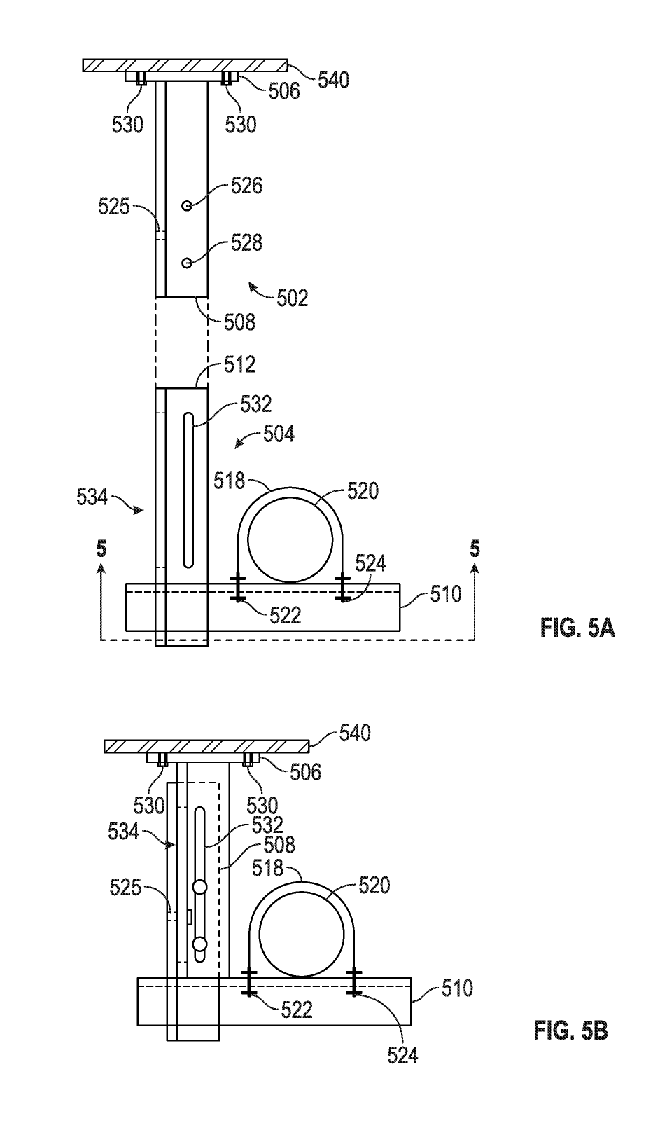

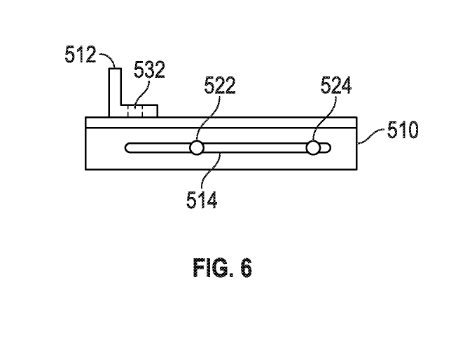

Referring now to FIGS. 5A-5B, an elevational view illustrates another embodiment of an adjustable support comprising a stationary member 502 and a separate adjustable member 504 uncoupled (5A) and coupled (5B). The stationary member 502 includes a base 506 attached to a brace 508. The adjustable member 504 is coupled to the stationary member 502 and includes another base 510 attached to another brace 512 near one end of the another base 510, which supports an object (e.g. pipe 520). The another base 510 includes a base slot 514, which is illustrated in FIG. 6. In FIG. 6, a top view of the adjustable member 504 in FIG. 5A along 5-5 illustrates the base slot 514 for receipt of a plurality of different sized clamps. The base slot 514 may have different lengths. A clamp 518 has a preferred predetermined size based on a size of the object (e.g. pipe 520) to secure the object to the another base 510 and restrict lateral movement of the object. Each end of the clamp 518 is secured within the base slot 514 by bolts 522, 524. The base slot 514 permits receipt of a plurality of different sized clamps to secure different sized objects to the another base 510.

The brace 508 includes one opening 525 on one side of the brace 508 and two openings 526, 528 on another side of the brace 508. The one opening 525 and the two openings 526, 528 are also positioned near one end of the brace 508 opposite another end of the brace 508 attached to the base 506. Alternatively, the one opening 525 may be likewise positioned on one side of the another brace 512 and the two openings 526, 528 may be likewise positioned on another side of the another brace 512. Both embodiments permit maximum adjustment between the stationary member 502 and the adjustable member 504. Other designs may be also be employed to achieve the same function such as using more or fewer openings on the one side of the brace 508 and/or on the another side of the brace 508. In both embodiments, the one opening 525 is positioned in a plane equidistantly between each respective plane within which the two openings 526, 528 are positioned to also permit maximum adjustment between the stationary member 502 and the adjustable member 504. Because the one opening 525 and the two openings 526, 528 each are designed for receipt of a respective bolt, their positioning further permits free access to adjust (tighten/loosen) the bolt positioned through the one opening 525 without interference with each bolt positioned through the respective two openings 526, 528. The base 506 is secured to a fixed surface (e.g. ceiling 540) by a plurality of bolts 530 or, alternatively, screws.

The another brace 512 includes a brace slot 532 on one side of the another brace 512 and another brace slot 534 on another side of the another brace 512. The brace slot 532 and the another brace slot 534 may have the same or different lengths, which are constrained by the length of the another brace 512. The length of the brace slot 532 and the another brace slot 534, however, is preferably maximized within the length of the another brace 512 without compromising the stability of the adjustable support. Alternatively, the brace slot 532 may be likewise positioned on one side of the brace 508 and the another brace slot 534 may be likewise positioned on another side of the brace 508. In both embodiments, the brace slot 532 and the another brace slot 534 are aligned with a respective one of the one opening 525 and the two openings 526, 528 for receipt of the bolt positioned through the respective one opening 525 and the two openings 526, 528. In this manner, the adjustable member 504 becomes slideably coupled to the stationary member 502 and may be moved in a direction perpendicular to the base 506 of the stationary member 502 from a minimum extended position to a maximum extended position. The adjustable member 504 may thus, be secured to the stationary member 502 at one of the minimum extended position, the maximum extended position and a position between the minimum extended position and the maximum extended position using the bolts positioned through the respective one opening 525 and the two openings 526, 528 and the respective brace slot 532 and the another brace slot 534. Preferably, each bolt is an A 325 grade or better and may be secured to the proper tension/torque and a load indicating washer. One locking nuts A194-2H for each bolt restricts slipping and the load indicating washer confirms the preloaded tension/torque have been achieved and a uniform distribution of stress about the contact area without having to take frequent measurements. Other coupling mechanisms and slot arrangements, however, may be employed to similarly move and secure the adjustable member.

Preferably, the brace 508, the another base 510 and the another brace 512 are 90° angle iron, however, may be made from any other material similar in strength, without an angle and/or with additional 90° angle iron for further support in the form of a square tubular design. The brace 508, the another base 510 and the another brace 512 may also have different lengths, which are determined by the support parameters such as the size and weight of the object to be supported. The base 506 may be attached to the brace 508 by a fillet weld. Likewise, the another base 510 may be attached to the another brace 512 by a fillet weld. Other techniques and means, however, may be employed to attached the same components while maintaining the required stability for support. The adjustable support illustrated in FIGS. 5-6 evenly distributes the load from the weight of the object supported so that less stress is imposed at each point where the foregoing components are attached.

The adjustable support described in reference to FIGS. 3-6 is prefabricated, fully adjustable, and interchangeable with other supports so that tracking is not necessary. The adjustable support thus, overcomes the prior art disadvantages.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. An adjustable support, which comprises:
a stationary member having a base attached to a brace;
an adjustable member coupled to the stationary member, the adjustable member having another base attached to another brace and the another base including at least one of a base slot and another base slot for receipt of a plurality of different sized clamps;
wherein one of the brace and the another brace includes one opening on one side of the brace or the another brace and two openings on another side of the brace or the another brace, the one opening positioned in a plane between each respective plane within which the two openings are positioned;
wherein one of the brace and the another brace includes a brace slot on one side of the brace or the another brace and another brace slot on another side of the brace or the another brace, the brace slot and the another brace slot aligned with a respective one of the one opening and the two openings; and
wherein the brace slot and the another brace slot have different lengths.

2. The support of claim 1, wherein the adjustable member is slideably coupled to the stationary member.

3. The support of claim 1, wherein the base is securely fastened to one of a floor and a ceiling.

4. The support of claim 1, wherein the brace, the another brace and the another brace are 90° angle iron.

5. (canceled)

6. The support of claim 1, wherein the opening and the two openings are positioned near one end of the brace or the another brace opposite another end of the brace or the another brace attached to the respective base or the another base.

7. (canceled)

8. (canceled)

9. The support of claim 1, wherein the adjustable member is moveable in a direction perpendicular to the base of the stationary member from a minimum extended position to a maximum extended position.

10. The support of claim 9, wherein the adjustable member is secured to the stationary member at one of the minimum extended position, the maximum extended position and a position between the minimum extended position and the maximum extended position.

11. The support of claim 1, wherein the another brace is attached to the another base between each end of the another base.

12. The support of claim 11, wherein the another base includes the base slot and the another base slot, the base slot and the another base slot being positioned opposite each other relative to a position where the another brace is attached to the another base.

13. The support of claim 11, wherein the another brace is attached to the another base near one end of the another base.

14. The support of claim 13, wherein the another base includes the base slot.

15. The support of claim 1, wherein each end of one of the plurality of different sized clamps is secured within the slot.

16. The support of claim 1, wherein one end of one of the plurality of different sized clamps is secured within the base slot and another end of the one of the plurality of different size clamps is secured within the another base slot.

17. (canceled)

18. (canceled)

19. (canceled)

20. (canceled)
